(19) United States
(12) Patent Application Publication
(10) Pub. No.: US 2011/0232055 A1
(43) Pub. Date: Sep. 29, 2011

(54) METHOD OF MANUFACTURING ELECTROLYTIC CAPACITOR

(75) Inventors: Takeshi Furukawa, Kanzaki-shi (JP); Kentaro Koyanagi, Kishima-gun (JP)

(73) Assignees: SANYO ELECTRIC CO., LTD., Osaka (JP); SAGA SANYO INDUSTRIES CO., LTD., Kishima-gun (JP)

(21) Appl. No.: 13/071,734

(22) Filed: Mar. 25, 2011

(30) Foreign Application Priority Data
Mar. 26, 2010 (JP) 2010-073253

(51) Int. Cl. H01G 9/00

(52) U.S. Cl. 29/25.03

(57) ABSTRACT

A method of manufacturing an electrolytic capacitor according to the present invention includes the steps of: forming a capacitor element by winding an anode foil having a roughened surface on which a dielectric film is formed, a cathode foil, and a separator containing a synthetic fiber and a water-soluble binder; immersing the capacitor element in a chemical conversion solution containing water as a main solvent for re-chemical conversion; subjecting the capacitor element subjected to re-chemical conversion to first heat treatment at a temperature of not less than 60° C. and less than 100° C.; and subjecting the capacitor element subjected to the first heat treatment to second heat treatment at a temperature of not less than 150° C. and less than a melting point of the synthetic fiber.

This nonprovisional application is based on Japanese Patent Application No. 2010-073253 filed on Mar. 26, 2010 with the Japan Patent Office, the entire contents of which are hereby incorporated by reference.

### BACKGROUND OF THE INVENTION

1. Field of the Invention

The present invention relates to a method of manufacturing an electrolytic capacitor, and particularly to a method of manufacturing an electrolytic capacitor having a separator made of a synthetic fiber.

2. Description of the Related Art

In recent years, electronic devices have been digitized and increased in frequency, which requires a compact and large-capacity electrolytic capacitor having a low impedance even in a high frequency region.

As an electrolytic capacitor satisfying the above-described requirement, a wound-type electrolytic capacitor has been developed. The wound-type electrolytic capacitor has a configuration in which a liquid or solid electrolyte is impregnated in the gap between an anode foil and a cathode foil which are wound with a separator interposed therebetween. The wound-type configuration as described above allows implementation of a compact and large-capacity electrolytic capacitor.

Various studies have been made in order to improve the performance of this electrolytic capacitor. For example, Japanese Patent Laying-Open No. 2001-284179 discloses a method of manufacturing an electrolytic capacitor in which a capacitor element having a separator made of a vinylon fiber is subjected to heat treatment at 175° C. to 300° C. after the chemical conversion process of a cut section in order to prevent expansion during reflow and degradation of the characteristics.

Furthermore, Japanese Patent Laying-Open No. 2009-71324 discloses a method of manufacturing an electrolytic capacitor in which a capacitor element having a separator made of a cellulose fiber, an acrylic fiber and a binder is subjected to heat treatment at a temperature of 200° C. or higher after the chemical conversion process of a cut section in order to decrease the equivalent series resistance (ESR) of the electrolytic capacitor.

However, the above-described method of manufacturing an electrolytic capacitor causes a problem that the heat treatment after the chemical conversion process of a cut section results in a decrease in the electrical characteristics such as a capacitance, an ESR and a leakage current (LC) of the electrolytic capacitor and also a decrease in the reliability.

### SUMMARY OF THE INVENTION

Thus, the present invention aims to provide a method of manufacturing an electrolytic capacitor having high electrical characteristics and reliability.

The present invention provides a method of manufacturing an electrolytic capacitor including the steps of: forming a capacitor element by winding an anode foil having a roughened surface on which a dielectric film is formed, a cathode foil, and a separator containing a synthetic fiber and a water-soluble binder; immersing the capacitor element in a chemical conversion solution containing water as a main solvent for re-chemical conversion; subjecting the capacitor element subjected to re-chemical conversion to first heat treatment at a temperature of not less than 60° C. and less than 100° C.; and subjecting the capacitor element subjected to the first heat treatment to second heat treatment at a temperature of not less than 150° C. and less than a melting point of the synthetic fiber.

According to the present invention, a method of manufacturing an electrolytic capacitor having a high capacitance and reliability can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view schematically showing the structure of a wound-type electrolytic capacitor according to the present embodiment.

FIG. 2 is a diagram for illustrating the configuration of a capacitor element according to the present embodiment.

### DESCRIPTION OF THE PREFERRED EMBODIMENTS

The present inventors have conducted concentrated studies focusing attention on the fact that a part of the component eluted from the separator in the chemical conversion process of a cut section is fused into a dielectric film in the heat treatment process, which contributes to a decrease in the electrical characteristics and the reliability of the electrolytic capacitor. Consequently, the present inventors found that an electrolytic capacitor having a high capacitance and reliability can be manufactured by performing heat treatment processes in a step-by-step manner.

Embodiments of the present invention based on the above-described knowledge will be hereinafter described in detail with reference to the accompanying drawings, in which the same or corresponding components in each embodiment described below are designated by the same reference characters, and description thereof will not be repeated.

<<Capacitor Element Formation Process>>

First, according to the known chemical conversion treatment method, a dielectric film is formed on the surface of an anode foil 21 subjected to the surface-roughening treatment such as etching. For example, anode foil 21 is immersed in the known chemical conversion solution such as adipic acid ammonium solution and subjected to heat treatment or applied with a voltage, which allows a dielectric film to be formed on the surface of anode foil 21. A valve action metal such as aluminum, tantalum, niobium, and titanium can be used as anode foil 21. Furthermore, anode foil 21 subjected to the surface-roughening treatment such as etching has a surface provided with an innumerable number of pores thereon and also has an extremely large surface area.

Then, anode foil 21 having a dielectric film formed thereon and a cathode foil 22 are wound with a separator 23 interposed therebetween to fabricate a capacitor element 10 secured with a securing tape 24. Lead wires 14A and 14B each serving as a terminal are connected to anode foil 21 and cathode foil 22 through lead tabs 15A and 15B, respectively.

Separator 23 can be made of nonwoven fabric including a synthetic fiber and a binder, or the like. It is preferable that the synthetic fiber has a melting point or a decomposition temperature of 150° C. or higher. It is particularly preferable that the synthetic fiber includes at least one or more of a vinylon fiber, a nylon fiber, an acrylic fiber, a polyester fiber, and an aramid fiber. Above all, an aramid fiber is particularly preferable since it has a high heat resistance.

It is preferable to employ a water-soluble binder as a binder since it allows the separator to be readily impregnated with the chemical conversion solution during the re-chemical conversion treatment. Above all, polyvinyl alcohol (PVA) and polyacrylamide are preferable. PVA is particularly preferable since it allows a decrease in the ESR of the electrolytic capacitor.

When the content of the binder in separator 23 is too small, the tensile strength of separator 23 is decreased, which makes it difficult to wind the capacitor element. Therefore, it is preferable that the content of the binder in separator 23 is set at 5 weight percent or more. When the content of the binder is too large, the binder eluted in the re-chemical conversion process described later may close the pores in the anode foil to cause a decrease in the capacitance. Therefore, it is preferable that the content of the binder in separator 23 is set at 40 weight percent or less.

<<Re-Chemical Conversion Process>>

Then, capacitor element 10 formed by winding is subjected to re-chemical conversion treatment. The metal foil generally used for anode foil 21 is obtained by subjecting a large-sized metal foil to chemical conversion treatment and then cutting it into a desired size. Accordingly, a dielectric, film is not formed in the cut section corresponding to the cutting plane of anode foil 21. Furthermore, capacitor element 10 formed as described above may have a dielectric film damaged by stress and the like caused during the winding operation. The re-chemical conversion treatment is performed in order to form a dielectric film at the cut section of anode foil 21, to repair the damaged part of the dielectric film, or the like.

The re-chemical conversion treatment can be carried out by immersing capacitor element 10 in the chemical conversion solution and applying a voltage to anode foil 21 of capacitor element 10. The chemical conversion solution may be a solution (aqueous solution) containing water as a main solvent and containing a known chemical conversion accelerator such as adipic acid and phosphoric acid. It is preferable that the concentration of the chemical conversion accelerator is 0.1 to 10 weight percent and the temperature of the chemical conversion solution is 15 to 35° C. It is preferable that the period of time required for the re-chemical conversion treatment is 30 to 180 minutes.

Capacitor element 10 pulled up from the chemical conversion solution may be washed with the wash water such as pure water.

<<First Heat Treatment Process>>

Capacitor element 10 subjected to the re-chemical conversion process is subjected to the first heat treatment, thereby evaporating the moisture remaining in capacitor element 10. The moisture remaining in capacitor element 10 corresponds to the moisture contained in the chemical conversion solution used in the re-chemical conversion treatment or the wash water. It is preferable to perform the first heat treatment at a temperature lower than 100° C. that is a boiling point of water used as a solvent of the chemical conversion solution and the wash water.

The moisture remaining in capacitor element 10 contains a component of an eluted synthetic fiber, binder and the like from separator 23. Accordingly, when the heat treatment is performed at a temperature of 100° C. or higher, the eluted component is impregnated into the deep portion of the pores of anode foil 21 due to the diffusion effect caused by rapid vaporization of the moisture. The impregnated eluted component is fused onto the surface of the dielectric film due to heat. Consequently, the capacitance of the electrolytic capacitor is reduced.

According to the present invention, the first heat treatment is carried out at a temperature lower than 100° C., which allows the evaporation rate of the moisture remaining in capacitor element 10 to slow down. Therefore, the eluted component can be prevented from being impregnated into the deep portion of the pores of anode foil 21, thereby preventing the eluted component from being fused onto the dielectric film. Consequently, a decrease in the capacitance of the electrolytic capacitor can be suppressed. Furthermore, in the case where the amount of the binder contained in separator 23 is relatively large, and particularly 20% or more, the eluted component is increased, which causes a significant decrease in the capacitance. However, a decrease in the capacitance can be more effectively suppressed by performing the present process.

Furthermore, it is preferable that the first heat treatment is performed at a temperature of 60° C. or higher in order to reliably remove the moisture. The period of time required for the first heat treatment is preferably 10 minutes or longer in order to reliably remove the moisture, and preferably 60 minutes or shorter in terms of production efficiency.

<<Second Heat Treatment Process>>

Then, capacitor element 10 subjected to the first heat treatment is subjected to the second heat treatment at a temperature higher than that of the first heat treatment process. By performing the present process, the reliability of the electrolytic capacitor is improved by the anneal effect of anode foil 21 and cathode foil 22.

It is preferable that the second heat treatment is carried out at a temperature of 150° C. or higher in order to achieving a sufficient anneal effect of anode foil 21 and cathode foil 22. When the second heat treatment temperature is too high, the synthetic fiber contained in the separator is fused or thermally decomposed. This causes deterioration of the electrical characteristics such as an ESR and an LC of the electrolytic capacitor. Accordingly, it is preferable that the second heat treatment is carried out at a temperature lower than the melting point or the decomposition temperature of the synthetic fiber contained in the separator.

Furthermore, the period of time required for the second heat treatment is preferably 10 minutes or longer for the purpose of achieving the anneal effect of anode foil 21 and cathode foil 22, and preferably 180 minutes or shorter in terms of production efficiency.

<<Electrolyte Impregnation Process>>

Then, capacitor element 10 subjected to the second heat treatment is impregnated with electrolyte. Examples of the electrolyte may include an electrolytic solution containing y-butyrolactone and the like, and a solid electrolyte containing manganese dioxide, TCNQ complex, a conductive polymer, and the like. Examples of the conductive polymer may include a polymer such as polypyrrole, polythiophene, polyfuran, or polyaniline, or a derivative thereof. It is particularly preferable that a conductive polymer is applied to the present invention for reasons of heat resistance and thermal stability. Furthermore, since the conductivity of polythiophene or a derivative thereof is high, a polymer made of polythiophene or a derivative thereof is preferable, and a polymer made of polyethylene dioxythiophene is particularly preferable. Furthermore, examples of the method of impregnating capacitor element 10 with a conductive polymer may include a known method such as chemical polymerization and electrolytic polymerization.

<<Sealing Process>>

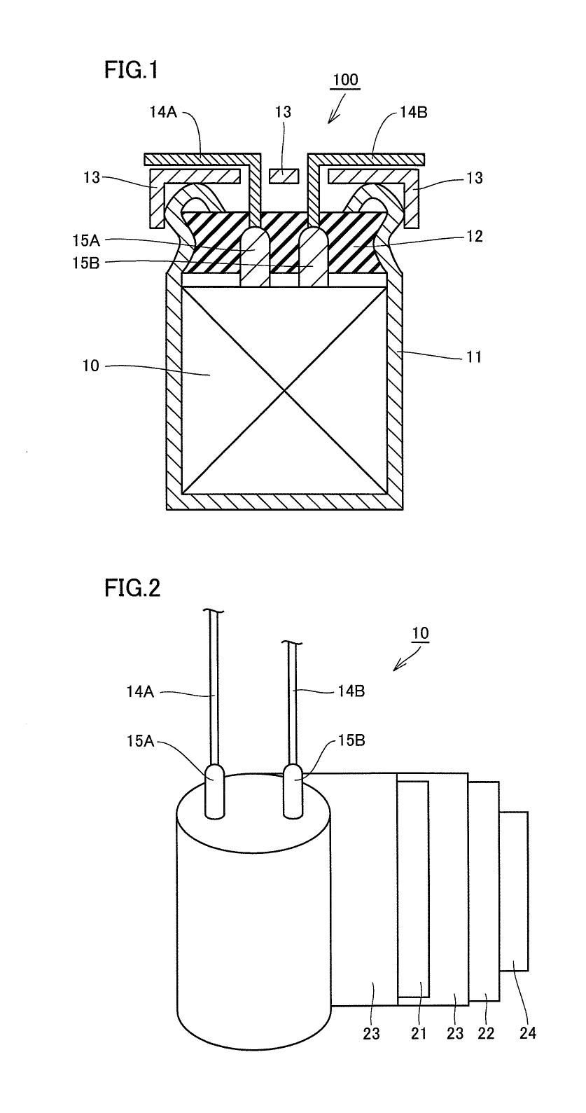

Capacitor element 10 produced by the above-described process is housed in a bottomed case 11, and a sealing member 12 formed such that lead wires 14A and 14B pass therethrough is disposed on the upper surface of capacitor element 10. Consequently, capacitor element 10 is sealed within bottomed case 11. Furthermore, the vicinity of the open end of bottomed case 11 is subjected to pressing in a lateral direction and curling, and a seat plate 13 is disposed in the curled portion, with the result that an electrolytic capacitor 100 shown in FIG. 1 is produced.

### EXAMPLES

### Example 1

First, aluminum foil having a surface roughened by the etching treatment was immersed in the chemical conversion solution containing adipic acid ammonium solution and a voltage was applied thereto, thereby forming a dielectric film on the surface of the aluminum foil. Then, the aluminum foil having this dielectric film formed thereon was cut to produce anode foil 21 on which the dielectric film was formed. Lead wires 14A and 14B each serving as a terminal were connected through lead tabs 15A and 15B to anode foil 21 and cathode foil 22 made of aluminum foil, respectively. It is to be noted that a steel wire coated with copper was used for lead wires 14A and 14B. Anode foil 21 and cathode foil 22 were wound with separator 23 containing 90 weight percent of a vinylon fiber and 10 weight percent of polyvinyl alcohol (PVA) interposed therebetween, and secured with securing tape 24 to produce capacitor element 10.

Then, capacitor element 10 was immersed in the chemical conversion solution at 25° C. made of 2.0 weight percent of an adipic acid ammonium solution, and a voltage of 8V was applied thereto for 60 minutes, thereby performing the re-chemical conversion treatment.

After capacitor element 10 pulled up from the chemical conversion solution was subjected to the first heat treatment at a temperature of 85° C. and for 30 minutes, the second heat treatment was carried out at a temperature of 220° C. and for 60 minutes.

Then, a polymerization solution was prepared by mixing 3,4-ethylene dioxythiophene as a monomer and a butyl alcohol solution containing ferric p-toluenesulfonic acid as an oxidizer at the weight ratio of 1:3. Capacitor element 10 was immersed in the polymerization solution and pulled up therefrom. Then, capacitor element 10 was heated at 250° C. to form a conductive polymer made of polyethylene dioxythiophene within capacitor element 10.

Then, produced capacitor element 10 was housed in an aluminum case as bottomed case 11, and a rubber member as sealing member 12 was disposed on the upper surface of housed capacitor element 10 such that lead wires 14A and 14B passed through the rubber member. The vicinity of the open end of bottomed case 11 was then subjected to pressing in a lateral direction and curling, and a plastic plate as seat plate 13 was disposed in the curled portion. Finally, lead wires 14A and 14B were subjected to pressing and bending followed by aging, thereby producing an electrolytic capacitor as shown in FIG. 1.

### Example 2

An electrolytic capacitor was manufactured by the same method as in Example 1 except that separator 23 containing 90 weight percent of a nylon fiber and 10 weight percent of PVA was used as a separator.

### Example 3

An electrolytic capacitor was manufactured by the same method as in Example 1 except that separator 23 containing 90 weight percent of an acrylic fiber and 10 weight percent of PVA was used as a separator.

### Example 4

An electrolytic capacitor was manufactured by the same method as in Example 1 except that separator 23 containing 90 weight percent of an aramid fiber and 10 weight percent of PVA was used as a separator.

### Example 5

An electrolytic capacitor was manufactured by the same method as in Example 1 except that the first heat treatment temperature was set at 120° C.

### Example 6

An electrolytic capacitor was manufactured by the same method as in Example 1 except that the second heat treatment temperature was set at 145° C.

### Example 7

An electrolytic capacitor was manufactured by the same method as in Example 1 except that the second heat treatment temperature was set at 280° C.

### Example 8

An electrolytic capacitor was manufactured by the same method as in Example 4 except that the second heat treatment temperature was set at 280° C.

### Example 9

An electrolytic capacitor was manufactured by the same method as in Example 4 except that the content of PVA was set at 40%.

### Example 10

An electrolytic capacitor was manufactured by the same method as in Example 4 except that the content of PVA was set at 50%.

### Comparative Example 1

An electrolytic capacitor was manufactured by the same method as in Example 1 except that the second heat treatment was performed at 220° C. without performing the first heat treatment.

### Comparative Example 2

An electrolytic capacitor was manufactured by the same method as in Example 1 except that the second heat treatment was performed at 85° C. without performing the first heat treatment.

### Comparative Example 3

An electrolytic capacitor was manufactured by the same method as in Example 2 except that the second heat treatment was performed at 220° C. without performing the first heat treatment.

### Comparative Example 4

An electrolytic capacitor was manufactured by the same method as in Example 3 except that the second heat treatment was performed at 220° C. without performing the first heat treatment.

### Comparative Example 5

An electrolytic capacitor was manufactured by the same method as in Example 4 except that the second heat treatment was performed at 220° C. without performing the first heat treatment.

### Comparative Example 6

An electrolytic capacitor was manufactured by the same method as in Comparative Example 5 except that the content of PVA was set at 40%.

For the purpose of facilitating the comparison between Examples 1 to 10 and Comparative Examples 1 to 6 as described above, the separator and the heat treatment conditions used in each of Examples and Comparative Examples are summarized in Table 1.

TABLE 1

| | Type of | Content of | First Heat | Second Heat |
|---|---|---|---|---|
| | Synthetic Fiber | PVA | Treatment | Treatment |
| Example 1 | Vinylon Fiber | 10% | 85° C. | 220° C. |
| Example 2 | Nylon Fiber | 10% | 85° C. | 220° C. |
| Example 3 | Acrylic Fiber | 10% | 85° C. | 220° C. |
| Example 4 | Aramid Fiber | 10% | 85° C. | 220° C. |
| Example 5 | Vinylon Fiber | 10% | 120° C. | 220° C. |
| Example 6 | Vinylon Fiber | 10% | 85° C. | 145° C. |
| Example 7 | Vinylon Fiber | 10% | 85° C. | 280° C. |
| Example 8 | Aramid Fiber | 10% | 85° C. | 280° C. |
| Example 9 | Aramid Fiber | 40% | 85° C. | 220° C. |
| Example 10 | Aramid Fiber | 50% | 85° C. | 220° C. |
| Comparative | Vinylon Fiber | 10% | — | 220° C. |
| Example 1 | | | | |
| Comparative | Vinylon Fiber | 10% | — | 85° C. |
| Example 2 | | | | |
| Comparative | Nylon Fiber | 10% | — | 220° C. |
| Example 3 | | | | |
| Comparative | Acrylic Fiber | 10% | — | 220° C. |
| Example 4 | | | | |
| Comparative | Aramid Fiber | 10% | — | 220° C. |
| Example 5 | | | | |
| Comparative | Aramid Fiber | 40% | — | 220° C. |
| Example 6 | | | | |

<Performance Evaluation>

The electrolytic capacitor in each of Examples and Comparative Examples has a rated voltage of 4 V and a rated capacitance of 150 μl. Furthermore, the electrolytic capacitor has a contour with a diameter of 6.3 mm and a height of 6 mm.

<<Initial Capacitance>>

For each of 20 electrolytic capacitors in each of Examples and Comparative Examples, an LCR meter of four-terminal type was used to measure the initial capacitance (μF) at a frequency of 120 Hz of each electrolytic capacitor. Each average value of the measurement results is shown in Table 2.

<<Initial ESR>>

For each of 20 electrolytic capacitors in each of Examples and Comparative Examples, an LCR meter of four-terminal type was used to measure the ESR (mΩ) at a frequency of 100 kHz of each electrolytic capacitor. Each average value of the measurement results is shown in Table 2.

<<tan δ>>

For each of 20 electrolytic capacitors in each of Examples and Comparative Examples, an LCR meter of four-terminal type was used to measure tan δ (%) at a frequency of 120 Hz of each electrolytic capacitor. Each average value of the measurement results is shown in Table 2.

<<Leakage Current>>

For each of 20 electrolytic capacitors in each of Examples and Comparative Examples, an LC (μA) obtained after application of a rated voltage of 4V for 2 minutes was measured. Each average value of the measurement results is shown in Table 2.

<<Reliability Test>>

The reliability test was performed for the electrolytic capacitor in each of Examples and Comparative Examples. Specifically, a rated voltage of 4V was applied to the electrolytic capacitor in each of Examples and Comparative Examples at a temperature of 125° C., and then kept for 500 hours.

<<Capacitance Change Rate>>

For each of 20 electrolytic capacitors subjected to the reliability test in each of Examples and Comparative Examples, the capacitance was measured by the method as described above to calculate the average thereof. Then, the initial capacitance as C0 and the capacitance obtained after the reliability test as C were substituted into the following equation (1) to calculate a capacitance change rate (ΔC (%)). The results are shown in Table 2.

ΔC(%)=(C−C0)/C0×100 (1)

<<ESR Change Rate>>

For each of 20 electrolytic capacitors subjected to the reliability test in each of Examples and Comparative Examples, the ESR was measured by the method as described above to calculate the average thereof. Then, the initial ESR as R0 and the ESR obtained after the reliability test as R were substituted into the following equation (2) to calculate an ESR change rate (ΔR (times)). The results are shown in Table 2.

ΔR(times)=R/R0 (2)

TABLE 2

| | | | | | Capacitance | ESR |
|---|---|---|---|---|---|---|
| | Initial | Initial | | | Change | Change |
| | Capacitance | ESR | tan δ | LC | Rate | Rate ΔR |
| | (μF) | (mΩ) | (%) | (μA) | ΔC (%) | (times) |
| Example 1 | 151 | 14.9 | 1.8 | 15 | −1.9 | 1.01 |
| Example 2 | 147 | 15.3 | 1.9 | 10 | −2.2 | 1.02 |
| Example 3 | 149 | 15.1 | 1.9 | 13 | −2.0 | 1.01 |
| Example 4 | 150 | 14.9 | 1.8 | 12 | −1.8 | 1.01 |
| Example 5 | 134 | 15.0 | 2.0 | 18 | −2.5 | 1.01 |
| Example 6 | 142 | 15.1 | 3.0 | 11 | −6.8 | 1.13 |
| Example 7 | 153 | 45.2 | 1.8 | 255 | −1.6 | 1.00 |
| Example 8 | 162 | 15.8 | 1.9 | 86 | −1.2 | 1.00 |
| Example 9 | 146 | 15.2 | 2.1 | 15 | −3.9 | 1.05 |
| Example 10 | 139 | 15.3 | 2.5 | 10 | −4.5 | 1.10 |
| Comparative | 126 | 14.8 | 2.2 | 14 | −2.8 | 1.02 |
| Example 1 | | | | | | |
| Comparative | 143 | 15.2 | 3.2 | 9 | −8.9 | 1.25 |
| Example 2 | | | | | | |
| Comparative | 115 | 15.2 | 2.0 | 18 | −3.2 | 1.03 |
| Example 3 | | | | | | |
| Comparative | 122 | 15.0 | 2.3 | 12 | −3.5 | 1.03 |
| Example 4 | | | | | | |
| Comparative | 131 | 14.9 | 2.3 | 16 | −3.9 | 1.04 |
| Example 5 | | | | | | |
| Comparative | 98 | 15.3 | 2.0 | 13 | −4.4 | 1.05 |
| Example 6 | | | | | | |

In Table 2, when comparing Examples 1 to 10 with Comparative Examples 1 to 6, the electrolytic capacitor in each of Examples 1 to 10 was larger in initial capacitance than the electrolytic capacitor in each of Comparative Examples 1 to 6. Accordingly, it was found that the electrolytic capacitor subjected to the first heat treatment is less influenced by the eluted component from the separator than the electrolytic capacitor not subjected to the first heat treatment, and thus, has an initial capacitance that is less likely to be decreased.

Furthermore, when comparing Example 9 with Comparative Example 6 each in which the PVA content of the separator was 40%, Example 9 subjected to the first and second heat treatments was larger in initial capacitance than Comparative Example 6 not subjected to the first heat treatment. Therefore, it was found that, when the first heat treatment is performed, the initial capacitance of the electrolytic capacitor becomes less likely to be decreased, even if the amount of the binder contained in the separator is relatively large.

When comparing Example 1 with Comparative Example 5, the electrolytic capacitor in Example 1 subjected to the first heat treatment at a temperature of 85° C. was larger in initial capacitance than the electrolytic capacitor in Example 5 subjected to the first heat treatment at a temperature of 120° C. Consequently, it was found that the initial capacitance could be further increased by performing the first heat treatment at a temperature lower than the boiling point of water.

When comparing Example 1 with Example 6, the electrolytic capacitor in Example 1 subjected to the second heat treatment at a temperature of 220° C. was lower in capacitance change rate and ESR change rate than the electrolytic capacitor in Example 6 subjected to the second heat treatment at a temperature of 145° C. Consequently, it was found that the capacitance change rate and the ESR change rate could be suppressed low by performing the second heat treatment at a relatively high temperature.

Furthermore, when comparing Example 7 with Example 8 each in which the second heat treatment was performed at a temperature of 280° C., the electrolytic capacitor in Example 7 having a separator made of a vinylon fiber was greater in the initial ESR and the LC than the electrolytic capacitor in Example 8 having a separator made of an aramid fiber. It is considered that this is because the melting point (decomposition temperature) of the aramid fiber is 400° C. or higher whereas the melting point (decomposition temperature) of the vinylon fiber is about 240° C., and therefore, in the electrolytic capacitor in Example 7 subjected to the second heat treatment at a temperature higher than the melting point of the separator, the anode foil was damaged by the melted separator. Consequently, it was found that the initial ESR and the LC could be suppressed low by performing the second heat treatment at a temperature lower than the melting point of the synthetic fiber contained in the separator of the electrolytic capacitor.

When comparing Examples 4, 9 and 10, the less the PVA content of the separator was, the higher the capacitance was. Particularly in Examples 4 and 9 in which the content of the PVA was 40% or lower, the ESR change rate was also low.

Although the present invention has been described and illustrated in detail, it is clearly understood that the same is by way of illustration and example only and is not to be taken by way of limitation, the scope of the present invention being interpreted by the terms of the appended claims.

The present invention can be widely applied for improving the characteristics as an electrolytic capacitor.

What is claimed is:

1. A method of manufacturing an electrolytic capacitor, comprising the steps of:
forming a capacitor element by winding an anode foil having a roughened surface on which a dielectric film is formed, a cathode foil, and a separator containing a synthetic fiber and a water-soluble binder;
immersing said capacitor element in a chemical conversion solution containing water as a main solvent for re-chemical conversion;
subjecting said capacitor element subjected to re-chemical conversion to first heat treatment at a temperature of not less than 60° C. and less than 100° C.; and
subjecting said capacitor element subjected to the first heat treatment to second heat treatment at a temperature of not less than 150° C. and less than a melting point of said synthetic fiber.

2. The method of manufacturing an electrolytic capacitor according to claim 1, wherein said synthetic fiber includes at least one or more of a vinylon fiber, a nylon fiber, an acrylic fiber, a polyester fiber, and an aramid fiber.

3. The method of manufacturing an electrolytic capacitor according to claim 1, wherein said separator contains 5 to 40 weight percent of said water-soluble binder.

4. The method of manufacturing an electrolytic capacitor according to claim 1, wherein said water-soluble binder is polyvinyl alcohol or polyacrylamide.

5. The method of manufacturing an electrolytic capacitor according to claim 1, further comprising the step of, after said second heat treatment, impregnating said capacitor element with an electrolyte made of a conductive polymer.
